(19) United States
(12) Patent Application Publication
(10) Pub. No.: US 2007/0258447 A1
(43) Pub. Date: Nov. 8, 2007

(54) Inter-area summarization of edge-device addresses using RFC3107

(76) Inventors: Robert Raszuk, Komorow (PL); James N. Guichard, Groton, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/417,703

(22) Filed: May 4, 2006

(51) Int. Cl. H04L 12/56

(52) U.S. Cl. 370/389; 370/401

(57) ABSTRACT

A method, apparatus and computer program product for performing inter-area summarization for edge-device addressing are presented. A network is established, the network including a first ABR, an ingress Provider Edge (PE) device in communication with the first ABR, a second ABR in communication with the first ABR, and an egress PE in communication with the second ABR. The first ABR and the second ABR are connected via an RFC3107 BGP session, as are the ingress PE and the first ABR as well as the egress PE and second ABR. The method further includes performing packet forwarding including PE address summarization through the network.

Computer networks have become ubiquitous. Computer networks include the Internet, Service Provider (SP) networks, private networks, and Local Area Networks (LANs). A network such as an SP network may include peripherally located Provider Edge (PE) routers, each of which couples to one or multiple Customer Edge (CE) routers. The PE routers are used to maintain routing and forwarding context for each customer. The CE routers may couple to private LANs associated with one or multiple customers. The private LANs are also referred to as core networks. The CE site can be a MAN or WAN as well. The PE routers learn local customer routes from the CE routers and distribute remote customer routes to the CE router. The PEs use Border Gateway Protocol (BGP) to distribute customer routes to each other. To support operation, the PE routers typically maintain Virtual Routing and Forwarding (VRF) information in a table (a VRF table) dictating how to route and forward traffic through the shared physical network to support corresponding Virtual Private Networks (VPNs) for the different customers. VPNs provide a secured means for transmitting and receiving data between network nodes even though a corresponding physical network supporting propagation of the data is shared by many users.

For the core network, an ingress PE uses BGP functions to determine the egress PE. For example, the ingress PE puts the packet in a two-level Multi Protocol Label Switching (MPLS) stack. The top label is used to tunnel packets to the egress PE to accomplish MPLS forwarding through the core network. The bottom label is used by the egress PE to identify either the outgoing FIB rewrite adjacency or VRF table for another lookup. Alternately, an IP VPN may be used wherein PE to PE data is encapsulated in an IP header (e.g., IP, GRE, and L2TPv3)

Opaque LSAs are a class of LSA that include a standard LSA header followed by a 32-bit aligned application-specific information field. Like any other LSA, the opaque LSAa use the LS-database distribution mechanism for flooding information throughout the domain. The scope of the flooding is defined by the Opaque-LSA type.

RFC3107 specifies the way in which the label mapping information for a particular route is piggybacked in the same Border Gateway Protocol (BGP) Update message that is used to distribute the route itself. When BGP is used to distribute a particular route, it can be also be used to distribute a Multiprotocol Label Switching (MPLS) label which is mapped to that route. The label mapping information for a particular route is piggybacked in the same BGP Update message that is used to distribute the route itself.

This can be useful if two immediately adjacent Label Switched Routers (LSRs) are also BGP peers, then label distribution can be done without the need for any other label distribution protocol. Assume a network includes two “classes” of LSR, exterior LSRs which interface to other networks, and interior LSRs, which serve only to carry traffic between exterior LSRs. Suppose that the exterior LSRs are BGP speakers. If the BGP speakers distribute MPLS labels to each other along with each route they distribute, then as long as the interior routers support MPLS, they need not receive any of the BGP routes from the BGP speakers.

An environment wherein BGP Peers are not directly adjacent is described by way of the following LSR topology: A—B—C—D. Suppose that D distributes a label L to A. In this topology, A cannot simply push L onto a packet's frame stack, and then send the resulting packet to B. D must be the only LSR that sees L at the top of the stack. Before A sends the packet to B, it must push on another label, which was distributed by B. B must replace this label with yet another label, which was distributed by C. In other words, there must be an LSP between A and D. If there is no such LSP, A cannot make use of label L. This is true any time labels are distributed between non-adjacent LSRs, whether that distribution is done by BGP or by some other method.

### SUMMARY

Conventional mechanisms such as those explained above suffer from a variety of deficiencies. One such with conventional systems is that /32 addresses are included with the IGP outside of their local area.

Embodiments of the invention significantly overcome such deficiencies and provide mechanisms and techniques that provide a BGP option for PE address summarization and forwarding. This is accomplished by utilizing RFC3107 instead of the IGP to carry edge-device address and MPLS label information.

In a particular embodiment of a method for performing inter-area summarization for edge-device addressing, the method includes establishing a network comprising a first Area Border Router (ABR), an ingress Provider Edge (PE) device in communication with the first ABR, a second ABR in communication with the first ABR, and an egress PE in communication with the second ABR. The first ABR and the second ABR are connected via an RFC3107 BGP session, as are the ingress PE and the first ABR as well as the egress PE and second ABR. The method further includes performing packet forwarding including PE address summarization through the network.

Other embodiments include a computer readable medium having computer readable code thereon for performing inter-area summarization for edge-device addressing. The medium includes instructions for establishing a network comprising a first ABR, an ingress PE device in communication with the first ABR, a second ABR in communication with the first ABR, an egress PE in communication with the second ABR. The first ABR and the second ABR are connected via an RFC3107 BGP session, the ingress PE and the first ABR are connected via an RFC3107 BGP session, and the egress PE is connected to the second ABR via an RFC3107 BGP session. The medium further includes instructions for performing packet forwarding including PE address summarization through the network.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that performs inter-area summarization of edge-device addresses using RFC3107 as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing a BGP option for PE address summarization and forwarding as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Cisco Systems, Inc. of San Jose, Calif.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a block diagram of a network environment performing inter-area summarization of edge-device addresses using RFC3107 in accordance with embodiments of the invention;

FIG. 2 shows the frame stacks as a packet traverses the network as part of performing inter-area summarization of edge-device addresses using RFC3107;

FIGS. 3A and 3B depict a flow diagram of a particular method of performing inter-area summarization of edge-device addresses using RFC3107 in accordance with embodiments of the invention; and

FIG. 4 illustrates an example network device architecture for a computer system that performs inter-area summarization of edge-device addresses using RFC3107 in accordance with embodiments of the invention.

### DETAILED DESCRIPTION

OSPF (Open Shortest Path First) protocol is a link-state protocol. The state of the link is a description of that interface and of its relationship to its neighboring routers. A description of the interface would include, for example, the IP address of the interface, the mask, the type of network it is connected to, the routers connected to that network and the like. The collection of all these link-states forms a link-state database. OSPF uses a link-state algorithm in order to build and calculate the shortest path to all known destinations. OSPF uses flooding to exchange link-state updates between routers. Any change in routing information is flooded to all routers in the network. Areas are introduced to put a boundary on the explosion of link-state updates. Flooding is limited to changes within an area. All routers within an area have the exact link-state database. Routers that belong to multiple areas, and connect these areas to the backbone area are called area border routers (ABR). ABRs therefore maintain information describing the backbone areas and other attached areas. An area is interface specific. A router that has all of its interfaces within the same area is called an internal router (IR). A router that has interfaces in multiple areas is called an area border router.

Border Gateway Protocol (BGP) is an interautonomous system routing protocol. An autonomous system (AS) is a network or group of networks under a common administration and with common routing policies. BGP is used to exchange routing information for the Internet and is the protocol used between Internet Service Providers (ISPs).

When BGP is used between autonomous systems the protocol is referred to as External BGP (EBGP). If a service provider is using BGP to exchange routes within an AS, then the protocol is referred to as Interior BGP (IBGP). BGP neighbors exchange full routing information when the TCP connection between neighbors is first established. When changes to the routing table are detected, the BGP routers send to their neighbors only those routes that have changed. BGP routers do not send periodic routing updates, and BGP routing updates advertise only the optimal path to a destination network.

BGP uses many route parameters to define routing policies and maintain a stable routing environment. Routes learned via BGP have associated properties (also referred to as attributes) that are used to determine the best route to a destination when multiple paths exist to a particular destination. BGP also has mechanisms such as Outbound Route Filtering (ORF) which enable the proper set of Virtual Private Network (VPN) routing distribution constraints to be dynamically distributed. This reduces the management burden of setting up the constraints, and results in improved scalability.

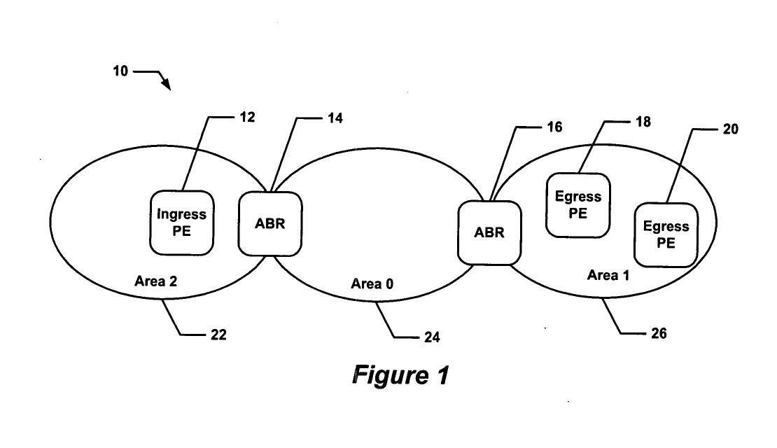

Referring now to FIG. 1, a particular embodiment of a system 10 performing inter-area summarization of edge-devices addresses using RFC3107 is shown. In this system, a first area 22 (area 2) includes an ingress PE (12) and a first Area Border Router (14). PE 12 and ABR 14 communicate via an RFC3107 BGP session. ABR14 is also in communication with a second ABR 16 in a second area 24 (area 0). ABR16 and ABR 14 also communicate via an RFC3107 BGP session. A third area 26 (area 1) includes ABR16 and two PE routers, PE 18 and PE 20. Both PEs are connected to the ABR 16 via an RFC3107 BGP session.

In this example, Egress PE 18 has an address of 2.2.2.2/32. Egress PE 20 has an address 2.2.2.3/32. A summary route covering all PEs in OSPF area 1 is 2.2.2.0/24. Ingress PE 12 has an address 2.2.3.2/32. A Summary route covering all PEs in OSPF area 2 is 2.2.3.0/24.

Routing Distribution is accomplished as follows. Egress PE 18 and Egress PE 20 loopback addresses are covered by 2.2.2.0/24 summary route within the IGP. Ingress PE 12 sees 1:x with next-hop Egress PE 18 {2.2.2.2}. Ingress PE 12 sees 2:y with next-hop Egress PE 20 {2.2.2.3}. ABR 16 generates a summary OSPF route 2.2.2.0/24 into area 0. ABR2 redistributes /32 routes coming from it's area covered by the summary route into BGP and enables RFC3107 mode for those. The next-hop for these routes is ABR2. Note that the /32 routes are not carried within the IGP into area 0.

ABR 14 receives summary 2.2.2.0/24 from area 0. ABR14 receives RFC3107 update from ABR 16 containing all the /32s from area 1, either directly or via Route Reflectors (RRs) which are not shown here. ABR 14 generates summary OSPF route 2.2.2.0/24 into local area 2. ABR 14 does next-hop-self, triggering new RFC3107 label assignment and propagates this information to PEs present in all local areas.

Ingress PE 12 installs BGP update containing {<2.2.2.2, label>, <2.2.2.3, label>} with next hop of ABR 14. Ingress PE 12 recurses the route via the local area IGP and applies the summary route (or default) on how to get to ABR 14. Ingress PE 12 matches VPNv4 routes containing PEs next-hops with routes received via RFC3107 and local IGP routes so as to populate its LFIB with {LDP label to reach ABR 14, RFC3107 label assigned by ABR 14 which will be mapped by ABR 14 to the one advertised by ABR 16, VPN label advertised by ingress PE via VPNv4 BGP sessions}.

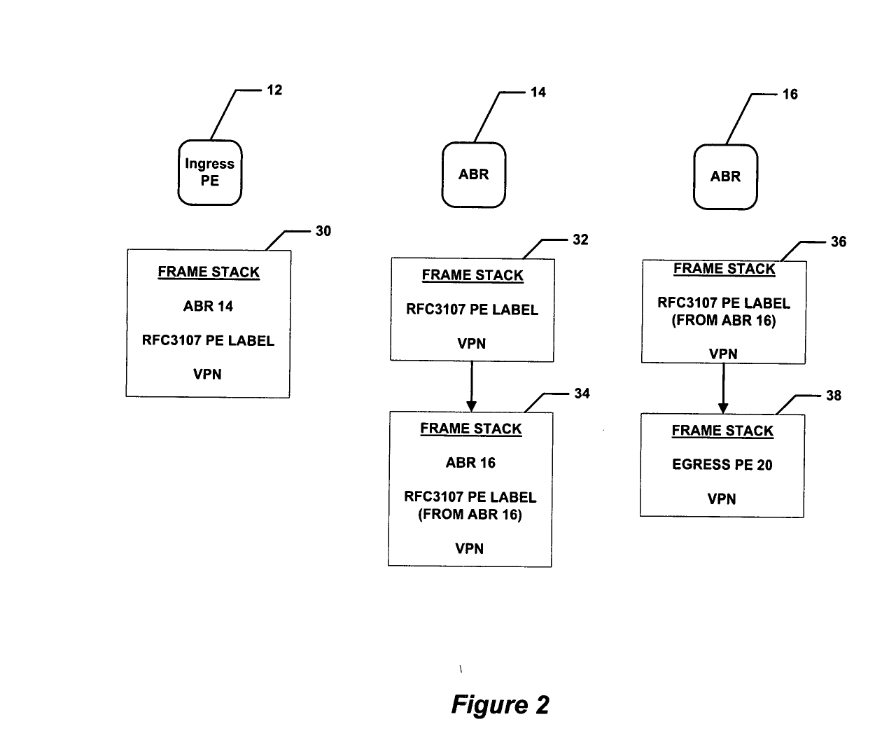

Referring to FIG. 2 in conjunction with FIG. 1, packet flow traversing the network 10 will be explained. Ingress PE 12 has route 1:x with {LDP label to reach ABR 14, RFC3107 label assigned by ABR 14 which will be mapped by ABR 14 to the one advertised by ABR 16, VPN label advertised by ingress PE via VPNv4 BGP sessions} frame stack entry 30 in LFIB. ABR 14 receives packet toward 1:x with frame stack 32 which now contains {RFC3107 label assigned by ABR 14 which will be mapped by ABR 14 to the one advertised by ABR 16, VPN label advertised by ingress PE via VPNv4 BGP sessions RFC3107}. ABR 14 swaps the {RFC3107 label assigned by ABR 14 which will be mapped by ABR 14 to the one advertised by ABR 16} label to the label received from ABR2 (also via RFC3107) and pushes on the IGP area 0 label to reach ABR2. Frame stack 34 now includes {LDP label to reach ABR 16, RFC3107 PE label from ABR 16, VPN label advertised by ingress PE via VPNv4 BGP sessions}.

ABR 16 receives packet toward 1:x with frame stack 36, which contains {RFC3107 PE label from ABR 16, VPN label advertised by ingress PE via VPNv4 BGP sessions RFC3107 PE label}. ABR 16 swaps {RFC3107 PE label from ABR 16} label for more specific /32 label of local PE from IGP/LDP. Frame stack 38 is now (Egress PE 20, VPN label advertised by ingress PE via VPNv4 BGP sessions RFC3107 PE label} and normal forwarding across area 1 is then applied. In such a manner address summarization is provided via BGP rather than via IGP.

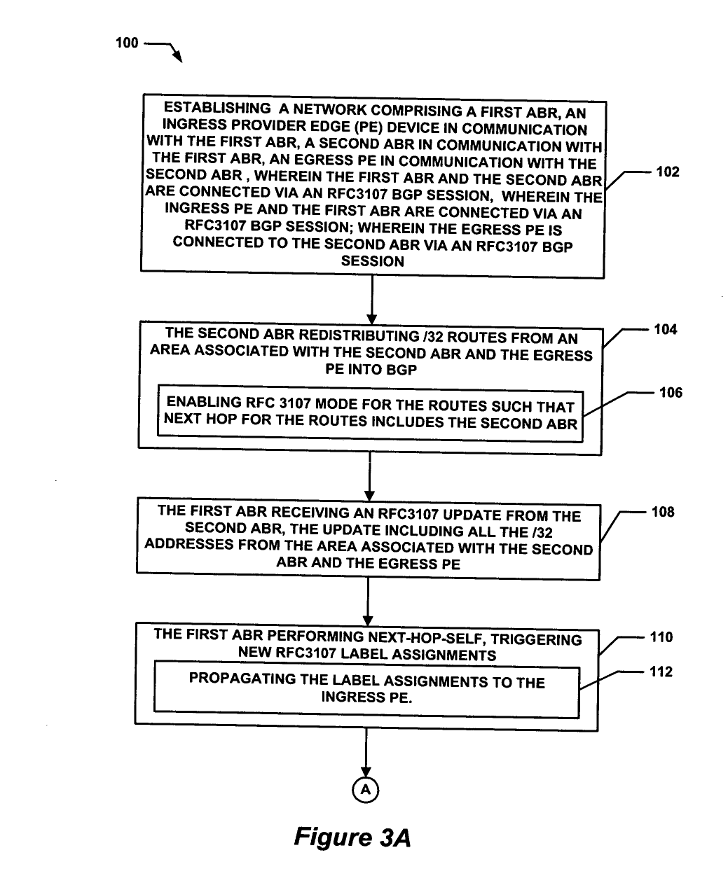

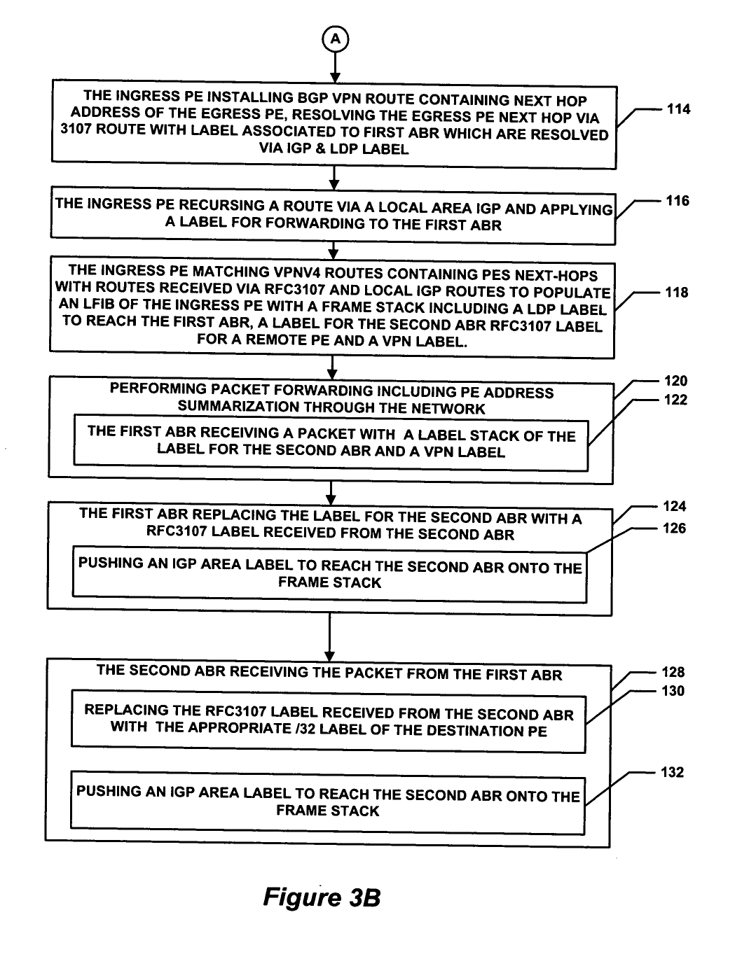

A flow chart of a particular embodiment of the presently disclosed method is depicted in FIGS. 3A and 3B. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIGS. 3A and 3B, a particular embodiment of a method 100 of performing inter-area summarization for edge-device addressing is shown. The method 100 begins with processing block 102 which discloses establishing a network comprising a first ABR, an ingress PE device in communication with the first ABR, a second ABR in communication with the first ABR, an egress PE in communication with the second ABR, wherein the first ABR and the second ABR are connected via an RFC3107 BGP session, wherein the ingress PE and the first ABR are connected via an RFC3107 BGP session, and wherein the egress PE is connected to the second ABR via an RFC3107 BGP session.

Processing block 104 states the second ABR redistributing /32routes from an area associated with the second ABR and the egress PE into BGP. Processing block 106 recites enabling RFC3107 mode for the routes such that a next-hop for the routes includes the second ABR.

The method continues with processing block 108 which discloses the first ABR receiving an RFC3107 update from the second ABR. This update includes all the /32 addresses from the area associated with the second ABR and the egress PE. This may be done directly or by way of Route Reflectors.

Processing block 110 discloses the first ABR performing next-hop-self, triggering new RFC3107 label assignments, and processing block 112 states propagating the label assignments to the ingress PE. These label assignment are propagated to PEs present in all local areas.

Processing block 114 recites the ingress PE installing BGP VPN route containing next hop address of the egress PE, resolving the first egress PE next hop via 3107 route with label associated to first ABR, which are resolved via IGP & LDP label.

Processing block 116 discloses the ingress PE recursing a route via a local area IGP and applying a label for forwarding to the first ABR. Processing block 118 states the ingress PE matching VPNv4 routes containing PEs next-hops with routes received via RFC3107 and local IGP routes to populate an LFIB of the ingress PE with a frame stack including a LDP label to reach the first ABR, a label for the second ABR RFC3107 label for a remote PE and a VPN label.

Processing block 120 recites performing packet forwarding including PE address summarization through the network. Processing block 122 discloses the first ABR receiving a packet with a frame stack of the label for the second ABR and a VPN label. Prior to this the frame stack included a label for the first ABR, an RFC3107 PE LABEL and a VPN.

Processing block 124 discloses the first ABR replacing the label for the second ABR with a RFC3107 label received from the second ABR. Processing block 126 states pushing an IGP area label to reach the second ABR onto the frame stack. The resulting frame stack now includes the label to reach the second ABR, the RFC3107 PE LABEL from the second ABR and the VPN.

Processing block 128 recites the second ABR receiving the packet from the first ABR. Processing block 130 discloses replacing the RFC3107 label received from the second ABR with the appropriate /32label of the destination PE. Processing block 132 states forwarding the packet to the destination PE.

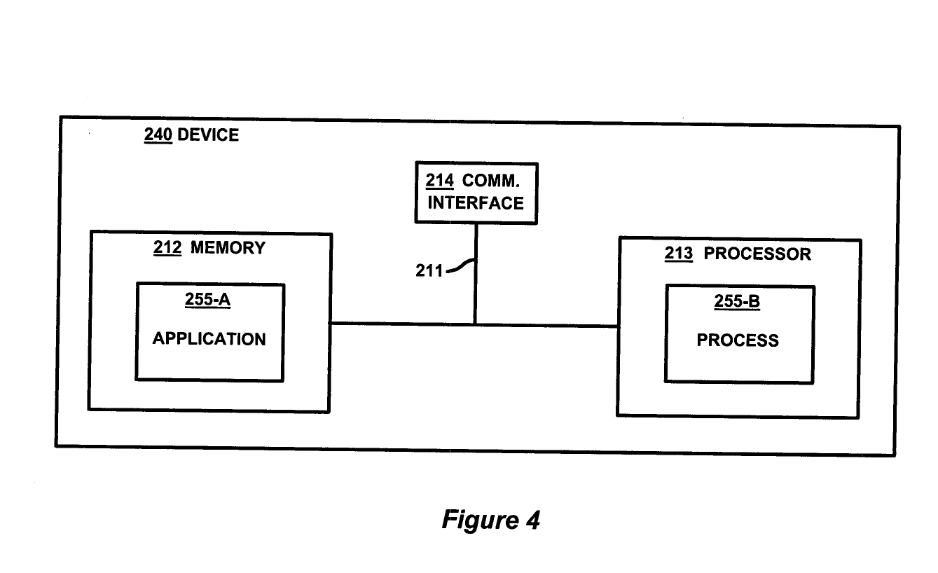

FIG. 4 illustrates example architectures of a network device that is configured as a host computer system 240. The network device 240 may be any type of computerized device system such as a personal computer, workstation, portable computing device, mainframe, server, ingress PE router, egress PE router, ABR, or the like. In this example, the device includes an interconnection mechanism 211 that couples a memory system 212, a processor 213, and a communications interface 214. The communications interface 214 allows the device 240 to communicate with external devices or systems.

The memory system 212 may be any type of computer readable medium that is encoded with an application 255-A that represents software code such as data and/or logic instructions (e.g., stored in the memory or on another computer readable medium such as a disk) that embody the processing functionality of embodiments of the invention as explained above. The processor 213 can access the memory system 212 via the interconnection mechanism 211 in order to launch, run, execute, interpret or otherwise perform the logic instructions of the applications for the device in order to produce a corresponding process 255-B. In other words, the process 255-B represents one or more portions of the application 255-A performing within or upon the processor 213 in the device.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 212 (e.g., within random access memory or RAM). It is also to be understood that other embodiments of the invention can provide the applications operating within the processor 213 as the processes. While not shown in this example, those skilled in the art will understand that the computer system may include other processes and/or software and hardware components, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that the invention should not be limited to the described embodiments but rather should be limited only by the spirit and scope of the appended claims.

What is claimed is:

1. A method of performing inter-area summarization for edge-device addressing, the method comprising:
establishing a network comprising a first ABR, an ingress Provider Edge (PE) device in communication with said first ABR, a second ABR in communication with said first ABR, an egress PE in communication with said second ABR, wherein said first ABR and said second ABR are connected via an RFC3107 BGP session, wherein said ingress PE and said first ABR are connected via an RFC3107 BGP session; wherein said egress PE is connected to said second ABR via an RFC3107 BGP session; and
performing packet forwarding including PE address summarization through said network.

2. The method of claim 1 wherein said establishing a network further comprises:
said second ABR redistributing /32routes from an area associated with said second ABR and said egress PE into BGP; and
enabling RFC 3107 mode for said routes such that a next-hop for said routes includes said second ABR.

3. The method of claim 2 further comprising;
said first ABR receiving an RFC3107 update from said second ABR, said update including all the /32addresses from said area associated with said second ABR and said egress PE;
said first ABR performing next-hop-self, triggering new RFC3107 label assignments; and
propagating said label assignments to said ingress PE.

4. The method of claim 3 further comprising:
said ingress PE installing BGP VPN route containing next hop address of said egress PE, resolving said first egress PE next hop via 3107 route with label associated to first ABR which are resolved via IGP & LDP label;
said ingress PE recursing a route via a local area IGP and applying a label for forwarding to said first ABR; and
said ingress PE matching VPNv4 routes containing PEs next-hops with routes received via RFC3107 and local IGP routes to populate an LFIB of said ingress PE with a frame stack including a LDP label to reach said first ABR, a label for said second ABR RFC3107 label for a remote PE and a VPN label.

5. The method of claim 4 wherein said performing packet forwarding including PE address summarization through said network comprises:
said first ABR receiving a packet with a frame stack of the label for said second ABR and a VPN label;
said first ABR replacing the label for the second ABR with a RFC3107 label received from said second ABR; and
pushing an IGP area label to reach said second ABR onto said frame stack.

6. The method of claim 5 further comprising:
said second ABR receiving the packet from said first ABR;
replacing the RFC3107 label received from said second ABR with the appropriate /32label of the destination PE; and
forwarding said packet to the destination PE.

7. A computer readable medium having computer readable code thereon for of performing inter-area summarization for edge-device addressing, the medium comprising:
instructions for establishing a network comprising a first ABR, an ingress Provider Edge (PE) device in communication with said first ABR, a second ABR in communication with said first ABR, an egress PE in communication with said second ABR, wherein said first ABR and said second ABR are connected via an RFC3107 BGP session, wherein said ingress PE and said first ABR are connected via an RFC3107 BGP session; wherein said egress PE is connected to said second ABR via an RFC3107 BGP session; and
instructions for performing packet forwarding including PE address summarization through said network.

8. The computer readable medium of claim 7 wherein said instructions for establishing a network further comprises:
instructions for said second ABR redistributing /32routes from an area associated with said second ABR and said egress PE into BGP; and
instructions for enabling RFC 3107 mode for said routes such that a next-hop for said routes includes said second ABR.

9. The computer readable medium of claim 8 further comprising;
instructions for said first ABR receiving an RFC3107 update from said second ABR, said update including all the /32addresses from said area associated with said second ABR and said egress PE;
instructions for said first ABR performing next-hop-self, triggering new RFC3107 label assignments; and
instructions for propagating said label assignments to said ingress PE.

10. The computer readable medium of claim 9 further comprising:
instructions for said ingress PE installing BGP VPN route containing next hop address of said egress PE, resolving said first egress PE next hop via 3107 route with label associated to first ABR which are resolved via IGP & LDP label;
instructions for said ingress PE recursing a route via a local area IGP and applying a label for forwarding to said first ABR; and
instructions for said ingress PE matching VPNv4 routes containing PEs next-hops with routes received via RFC3107 and local IGP routes to populate an LFIB of said ingress PE with a frame stack including a LDP label to reach said first ABR, a label for said second ABR RFC3107 label for a remote PE and a VPN label.

11. The computer readable medium of claim 10 wherein said instructions for performing packet forwarding including PE address summarization through said network comprises:
instructions for said first ABR receiving a packet with a frame stack of the label for said second ABR and a VPN label;
instructions for said first ABR replacing the label for the second ABR with a RFC3107 label received from said second ABR; and
instructions for pushing an IGP area label to reach said second ABR onto said frame stack.

12. The computer readable medium of claim 11 further comprising:
instructions for said second ABR receiving the packet from said first ABR;
instructions for replacing the RFC3107 label received from said second ABR with the appropriate /32label of the destination PE; and
instructions for forwarding said packet to the destination PE.

13. A network device performing as a ingress Provider Edge (PE) router, comprising:
a memory;
a processor;
a communications interface;
an interconnection mechanism coupling the memory, the processor and the communications interface; and
wherein the memory is encoded with an inter-area summarization for edge-device addressing application that when performed on the processor, provides a process for processing information, the process causing the computer system to be capable of performing the operations of:
establishing a network between an ingress Provider Edge (PE) device and a first ABR, wherein said ingress PE and said first ABR are connected via an RFC3107 BGP session; and
performing packet forwarding including PE address summarization through said network.

14. The network device of claim 13 wherein said ingress PE installs BGP VPN route containing next hop address of an egress PE, resolves said first egress PE next hop via 3107 route with label associated to a first ABR which are resolved via IGP & LDP label;
said ingress PE recurses a route via a local area IGP and applying a label for forwarding to said first ABR; and
said ingress PE matches VPNv4 routes containing PEs next-hops with routes received via RFC3107 and local IGP routes to populate an LFIB of said ingress PE with a frame stack including a LDP label to reach said first ABR, a label for said second ABR RFC3107 label for a remote PE and a VPN label.

15. A network device performing as a first ABR, comprising:
a memory;
a processor;
a communications interface;
an interconnection mechanism coupling the memory, the processor and the communications interface; and
wherein the memory is encoded with an inter-area summarization for edge-device addressing application that when performed on the processor, provides a process for processing information, the process causing the computer system to be capable of performing the operations of:
establishing a network comprising the first ABR, an ingress Provider Edge (PE) device in communication with said first ABR, a second ABR in communication with said first ABR, wherein said first ABR and said second ABR are connected via an RFC3107 BGP session, wherein said ingress PE and said first ABR are connected via an RFC3107 BGP session; and
performing packet forwarding including PE address summarization through said network.

16. The network device of claim 15 wherein said first ABR receives an RFC3107 update from said second ABR, said update including all the /32addresses from said area associated with said second ABR and said egress PE;
said first ABR performs next-hop-self, triggering new RFC3107 label assignments; and
said first ABR propagates said label assignments to said ingress PE.

17. The network device of claim 16 wherein said first ABR receives an RFC3107 update from a second ABR, said update including all the /32addresses from an area associated with said second ABR and said egress PE;
said first ABR performs next-hop-self, triggering new RFC3107 label assignments; and
said first ABR propagates said label assignments to said ingress PE.

18. A network device performing as a second ABR, comprising:
a memory;
a processor;
a communications interface;
an interconnection mechanism coupling the memory, the processor and the communications interface; and
wherein the memory is encoded with an inter-area summarization for edge-device addressing application that when performed on the processor, provides a process for processing information, the process causing the computer system to be capable of performing the operations of:
establishing a network comprising the second ABR in communication with a first ABR, an egress PE in communication with said second ABR, wherein said first ABR and said second ABR are connected via an RFC3107 BGP session, wherein said egress PE is connected to said second ABR via an RFC3107 BGP session; and
performing packet forwarding including PE address summarization through said network.

19. The network device of claim 18 wherein said second ABR redistributes /32routes from an area associated with said second ABR and said egress PE into BGP; and
enables RFC3107 mode for said routes such that a next-hop for said routes includes said second ABR.

20. The network device of claim 19 wherein said second ABR receives a packet from said first ABR;
replaces the RFC 3107 label received from said second ABR with the appropriate /32label of a destination PE; and
forwards said packet to the destination PE.

21. A communications system capable performing inter-area summarization for edge-device addressing, the system comprising:
a first ABR;
an ingress Provider Edge (PE) device in communication with said first ABR, wherein said ingress PE and said first ABR are connected via an RFC3107 BGP session;
a second ABR in communication with said first ABR, wherein said first ABR and said second ABR are connected via an RFC3107 BGP session; and
an egress PE in communication with said second ABR, wherein said egress PE is connected to said second ABR via an RFC3107 BGP session; and
wherein said ingress PE, said first ABR, said second ABR and said egress PE are connected by way of a network and wherein said system performs packet forwarding including PE address summarization through said network.

22. The system of claim 20 wherein said ingress PE installs BGP VPN route containing next hop address of an egress PE, resolves said first egress PE next hop via 3107 route with label associated to a first ABR which are resolved via IGP & LDP label;
said ingress PE recurses a route via a local area IGP and applying a label for forwarding to said first ABR; and
said ingress PE matches VPNv4 routes containing PEs next-hops with routes received via RFC3107 and local IGP routes to populate an LFIB of said ingress PE with a frame stack including a LDP label to reach said first ABR, a label for said second ABR RFC3107 label for a remote PE and a VPN label.

23. The system of claim 20 wherein said first ABR receives an RFC3107 update from said second ABR, said update including all the /32addresses from said area associated with said second ABR and said egress PE;
said first ABR performs next-hop-self, triggering new RFC3107 label assignments;
said first ABR propagates said label assignments to said ingress PE;
said first ABR receives an RFC3107 update from a second ABR, said update including all the /32addresses from an area associated with said second ABR and said egress PE;
said first ABR performs next-hop-self, triggering new RFC3107 label assignments; and
said first ABR propagates said label assignments to said ingress PE.

24. The network device of claim 20 wherein said second ABR redistributes /32routes from an area associated with said second ABR and said egress PE into BGP;
enables RFC 3107 mode for said routes such that a next-hop for said routes includes said second ABR;
receives a packet from said first ABR;
replaces the RFC3107 label received from said second ABR with the appropriate /32label of a destination PE; and
forwards said packet to the destination PE.
